(19) United States
(12) Patent Application Publication
(10) Pub. No.: US 2024/0062936 A1
(43) Pub. Date: Feb. 22, 2024

(54) METHOD OF PRODUCING RARE EARTH MAGNETIC POWDER AND RARE EARTH MAGNETIC POWDER

(71) Applicants: NICHIA CORPORATION, Anan-shi (JP); TOYOTA JIDOSHA KABUSHIKI KAISHA, Toyota-shi (JP)

(72) Inventors: Hisashi MAEHARA, Itano-gun (JP); Masaaki ITO, Anjo-shi (JP); Tomonori INUZUKA, Toyota-shi (JP); Motoki HIRAOKA, Toyota-shi (JP)

(73) Assignees: NICHIA CORPORATION, Anan-shi (JP); TOYOTA JIDOSHA KABUSHIKI KAISHA, Toyota-shi (JP)

(21) Appl. No.: 18/448,689

(22) Filed: Aug. 11, 2023

(30) Foreign Application Priority Data
Aug. 17, 2022 (JP) 2022-130040
Jun. 14, 2023 (JP) 2023-097591

(51) Int. Cl. H01F 1/059; H01F 1/055; H01F 41/02

(52) U.S. Cl. CPC H01F 1/059; H01F 1/0552; H01F 1/0558; H01F 41/0266; H01F 41/026

(57) ABSTRACT

A method of producing a rare earth magnetic powder, the method including: heat-treating a mixture containing a SmFeN-based magnetic powder containing Sm, Fe, and N and a modifier powder containing Zn; and dispersing the heat-treated SmFeN-based magnetic powder using a resin-coated metal media or a resin-coated ceramic media.

### CROSS-REFERENCE TO RELATED PATENT APPLICATION

This application claims priority to Japanese Patent Application No. 2022-130040 filed on Aug. 17, 2022, and Japanese Patent Application No. 2023-097591 filed on Jun. 14, 2023. The disclosures of Japanese Patent Application No. 2022-130040 and Japanese Patent Application No. 2023-097591 are hereby incorporated by reference in their entirety.

### BACKGROUND

The present disclosure relates to a method of producing a rare earth magnetic powder and a rare earth magnetic powder.

JP 2015-195326 A discloses a production method involving grinding a SmFeN-based anisotropic magnetic powder using ceramic media in a solvent. However, the use of hard ceramic media is considered to cause chipping to form fine particles, so that the ground SmFeN-based anisotropic magnetic powder has a higher oxygen content and lower magnetic properties.

WO 2015/199096 discloses a method of producing a SmFeN-based rare earth magnet, which includes pre-compacting a SmFeN-based anisotropic magnetic powder in a magnetic field of not lower than 6 kOe, followed by warm compaction at a temperature of not higher than 600° C. and a contact pressure of 1 to 5 GPa.

### SUMMARY

Certain embodiments of the present disclosure aims to provide a method of producing a rare earth magnetic powder and a rare earth magnetic powder with high magnetic properties.

Exemplary embodiments of the present disclosure relate to a method of producing a rare earth magnetic powder, the method including:
heat-treating a mixture comprising a SmFeN-based magnetic powder containing Sm, Fe, and N and a modifier powder containing Zn; and
dispersing the heat-treated SmFeN-based magnetic powder using a resin-coated media or a resin-coated ceramic media.

Exemplary embodiments of the present disclosure relate to a SmFeN-based rare earth magnetic powder, containing Sm, Fe, and N,
wherein the SmFeN-based rare earth magnetic powder contains at least 6% by mass but not more than 10% by mass of Zn based on a total amount of the rare earth magnetic powder, and
wherein the SmFeN-based rare earth magnetic powder has a particle size D50 corresponding to a 50th percentile of a cumulative particle size distribution by volume of the SmFeN-based rare earth magnetic powder that is at least 1 μm but not more than 4 μm, a residual magnetization σr that is not less than 120 emu/g, and a squareness ratio Hk that is not less than 13000 Oe.

The above embodiments can provide a method of producing a rare earth magnetic powder and a rare earth magnetic powder with high magnetic properties.

### BRIEF DESCRIPTION OF DRAWINGS

FIG. 1A shows an exemplary SEM image of a powder mixture after the magnetic powder was mixed with a modifier powder but before the heat-treatment of the powder mixture in Example 3.

FIG. 1B shows an exemplary enlarged SEM image of the powder mixture after the magnetic powder was mixed with a modifier powder but before the heat-treatment of the powder mixture in Example 3.

FIG. 2A shows an exemplary SEM image of a rare earth magnetic powder prepared in Example 3.

FIG. 2B shows an exemplary enlarged SEM image of the rare earth magnetic powder prepared in Example 3.

FIG. 3A shows an exemplary SEM image of a rare earth magnetic powder prepared in Example 6.

FIG. 3B shows an exemplary enlarged SEM image of the rare earth magnetic powder prepared in Example 6.

FIG. 4A shows an exemplary SEM image of a rare earth magnetic powder prepared in Example 9.

FIG. 4B shows an exemplary enlarged SEM image of the rare earth magnetic powder prepared in Example 9.

FIG. 5A shows an exemplary SEM image of a rare earth magnetic powder prepared in Example 11.

FIG. 5B shows an exemplary enlarged SEM image of the rare earth magnetic powder prepared in Example 11.

FIG. 6A shows the results of a STEM-EDX mapping analysis showing regions where Sm, Zn, and P are localized in the rare earth magnetic powder prepared in Example 11.

FIG. 6B shows the results of a STEM-EDX mapping analysis showing a region where Zn is localized in the rare earth magnetic powder prepared in Example 11.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

A method of producing a rare earth magnetic powder according to the present embodiments includes heat-treating a mixture containing a SmFeN-based magnetic powder containing Sm, Fe, and N and a modifier powder containing Zn; and dispersing the heat-treated SmFeN-based magnetic powder using a resin-coated metal media or a resin-coated ceramic media. The method according to the present embodiments may include mixing the SmFeN-based magnetic powder and the modifier powder into the mixture before heat-treating the mixture. In the step of heat-treating, heat-treatment may be performed simultaneously with mixing.

### Mixing Step

In the mixing step of mixing the SmFeN-based magnetic powder and the modifier powder, a SmFeN-based magnetic powder containing Sm, Fe, and N and a modifier powder containing Zn may be mixed to obtain a powder mixture. Any modifier powder containing Zn, such as zinc or a zinc alloy, may be used. The lower limit of the zinc or zinc alloy content of the modifier powder is not limited, and is preferably not less than 90% by mass, more preferably not less than 95% by mass. In view of residual magnetization, the amount of the modifier powder is preferably at least 2 parts by mass but not more than 20 parts by mass, more preferably at least 5 parts by mass but not more than 10 parts by mass, relative to 100 parts by mass of the SmFeN-based magnetic powder.

When a zinc alloy is represented by Zn-M², M² may be selected from elements which can be alloyed with Zn (zinc) to lower the melting onset temperature of the zinc alloy below the melting point of Zn, and unavoidable impurity elements. In this case, enhanced sinterability is obtained when the resulting rare earth magnetic powder is pressure-sintered. Examples of M² capable of lowering the melting point below that of Zn include elements capable of forming Zn-M² eutectic alloys. Typical examples of such M² elements include Sn, Mg, and Al, and combinations thereof, where Sn represents tin, Mg represents magnesium, and Al represents aluminum. M² may also be selected from elements which do not inhibit the melting point-lowering function of these elements and the properties of the product. Moreover, the term “unavoidable impurity elements” refers to impurity elements which are inevitably contained, such as impurities contained in the raw materials of the modifier powder, or the avoidance of which leads to a significant increase in production cost.

In the zinc alloy represented by Zn-M², the ratio (molar ratio) between Zn and M² may be appropriately set to give an appropriate heat-treatment temperature in the heat-treatment step described later. For example, the ratio (molar ratio) of M² to the total zinc alloy may be not lower than 0.05, not lower than 0.10, or not lower than 0.20, but may be not higher than 0.90, not higher than 0.80, not higher than 0.70, not higher than 0.60, not higher than 0.50, not higher than 0.40, or not higher than 0.30.

The particle size (median size) D50 of the modifier powder is not limited, and may be not less than 0.1 μm, not less than 0.5 μm, not less than 1 μm, or not less than 2 μm, but may be not more than 12 μm, not more than 11 μm, not more than 10 μm, not more than 9 μm, not more than 8 μm, not more than 7 μm, not more than 6 μm, not more than 5 μm, or not more than 4 μm. The particle size (median size) D50 is measured by a dry laser diffraction/scattering method, for example.

The modifier powder having a low oxygen content can absorb much oxygen from the SmFeN-based magnetic powder. From this point of view, the oxygen content of the modifier powder is preferably not more than 5.0% by mass, more preferably not more than 3.0% by mass, still more preferably not more than 1.0% by mass of the total modifier powder. However, extremely reducing the oxygen content of the modifier powder leads to an increase in production cost. From this point of view, the oxygen content of the modifier powder may be not less than 0.1% by mass, not less than 0.2% by mass, or not less than 0.3% by mass of the total modifier powder.

The mixing with the modifier powder may be performed by any method, such as using a mortar, a muller wheel mixer, an agitator mixer, a mechano-fusion system, a V-mixer, or a ball mill. These methods may be combined. Here, the term “V-mixer” refers to an apparatus equipped with two cylindrical vessels connected in a V shape in which the vessels may be rotated to repeatedly gather and separate the powder particles in the vessels by gravity and centrifugal force, thereby mixing them.

### Heat-Treatment Step

In the heat-treatment step, the powder mixture of the modifier powder containing Zn and the SmFeN-based magnetic powder may be heat-treated. The heat-treatment may allow the SmFeN-based magnetic powder to be coated with a layer containing Zn to form a Fe—Zn alloy phase as a coating on the surfaces of the particles. This can further strongly bind (hereinafter, also referred to as “solidify”) the particles of the SmFeN-based magnetic powder to the particles of the modifier powder and simultaneously promote the modification. At a heat-treatment temperature of not lower than 350° C., the Fe—Zn alloy phase can be formed on almost all the particles, thereby solidifying and modifying them. The heat-treatment temperature may be not lower than 360° C., not lower than 370° C., or not lower than 380° C. Moreover, the upper limit of the heat-treatment temperature is preferably not higher than 480° C., more preferably not higher than 440° C. At a heat-treatment temperature of higher than 480° C., Zn may penetrate into the magnetic powder, reducing the magnetic properties. When heat-treatment is performed in two stages, which will be described later, a first temperature may be higher than 480° C.

The heat-treatment duration is not limited, but is preferably not shorter than 10 hours, more preferably not shorter than 15 hours. As for the upper limit of the heat-treatment duration, the magnetic phase of the SmFeN-based magnetic powder may have a Th₂Zn₁₇ type and/or Th₂N₁₇ type crystalline structure, and the formation of a Fe—Zn alloy phase may saturate when the heat-treatment duration reaches 40 hours. In view of economic efficiency (reduction in time), the heat-treatment duration is preferably not longer than 40 hours, not longer than 35 hours, not longer than 30 hours, not longer than 25 hours, or not longer than 24 hours.

When a phosphate-treated SmFeN-based magnetic powder is used, the phosphorus coating layer may inhibit the formation of a Fe—Zn alloy layer. Hence, in order to promote the formation of a Fe—Zn alloy layer and obtain a rare earth magnetic powder having a high squareness ratio Hk, the heat-treatment temperature is preferably higher than the aforementioned heat-treatment temperature by 10° C. or more, more preferably by 20° C. or more.

To inhibit oxidation of the magnetic powder, heat-treatment is preferably performed in vacuum or in an inert gas atmosphere. Here, examples of the inert gas atmosphere include a nitrogen gas atmosphere. The concentration of nitrogen in the nitrogen gas atmosphere may be 90% by volume or more, preferably 95% by volume or more. When heat-treatment satisfying the aforementioned heat-treatment conditions is performed, a normal magnetic phase and a Fe—Zn alloy phase can be appropriately formed, inhibiting excessive interdiffusion between Fe and Zn.

In the heat-treatment step, the powder mixture of the SmFeN-based magnetic powder and the modifier powder may be heat-treated at a first temperature and then at a second temperature lower than the first temperature. The higher the heat-treatment temperature is, the more the reaction between the Fe of the SmFeN-based magnetic powder and the Zn of the modifier powder can be promoted. On the other hand, the higher the heat-treatment temperature is, the deeper the Zn can penetrate into the SmFeN-based magnetic powder. As the Zn penetrates deeper into the SmFeN-based magnetic powder, the resulting rare earth magnetic powder tends to have lower magnetic properties. The heat-treatment at the first temperature and the heat-treatment at the second temperature can promote the reaction between Fe and Zn and can inhibit the resulting rare earth magnetic powder from having lower magnetic properties. In the powder mixture that has undergone the heat-treatment at the first temperature, the modifier powder may or may not remain in the form of powder. The heat-treatment temperature and duration of the heat-treatment at the second temperature are as described above. The first temperature is preferably higher than the second temperature by 10° C. or more, more preferably by 20° C. or more. The first temperature is preferably equal to or higher than the melting point of Zn (419° C.). The first temperature may be at least 420° C. but not higher than 500° C., preferably at least 440° C. but not higher than 500° C. At such a temperature, the reaction between Zn and Fe can be promoted. When the magnetic powder that has undergone a phosphate treatment step is heat-treated, the first temperature may be at least 480° C. but not higher than 500° C. The second temperature is lower than the first temperature and may be at least 350° C. but not higher than 480° C., preferably at least 380° C. but not higher than 480° C. At such a temperature, the resulting rare earth magnetic powder can be inhibited from having lower magnetic properties. The heat-treatment duration of the heat-treatment at the first temperature is preferably shorter than the heat-treatment duration of the heat-treatment at the second temperature. In this case, the resulting rare earth magnetic powder can be more reliably inhibited from having lower magnetic properties. The heat-treatment duration of the heat-treatment at the first temperature may be not shorter than one minute, preferably not shorter than three minutes. The upper limit of the heat-treatment duration of the heat-treatment at the first temperature may be shorter than one hour, preferably shorter than 30 minutes. The heat-treatment duration of the heat-treatment at the second temperature may be longer than the heat-treatment duration of the heat-treatment at the first temperature and may be not shorter than one hour, preferably not shorter than 10 hours. The upper limit of the heat-treatment duration of the heat-treatment at the second temperature may be shorter than 30 hours, preferably shorter than 24 hours.

The heat-treatment is preferably performed without pressure to avoid solidification of the magnetic powder or the reduction of the magnetic properties due to the distortion of the SmFeN crystals.

### Dispersion Step

In the dispersion step, the SmFeN-based magnetic powder containing Sm, Fe, and N may be dispersed using a resin-coated metal media or a resin-coated ceramic media. The dispersion with such media can reduce peeling of the coating layer derived from the modifier powder containing Zn. Herein, the term “dispersion”, “dispersing”, or “dispersed” means that the aggregated particles in the SmFeN-based magnetic powder formed by heat-treatment, magnetic aggregation, etc. are separated into single particles or particles consisting of very few particles. According to the present embodiments, since the impact energy of collision between the SmFeN-based magnetic powder and the resin-coated metal or ceramic media is smaller than that between the SmFeN-based magnetic powder and non-resin coated metal or ceramic media, dispersion is more likely to occur than grinding. If the SmFeN-based magnetic powder is ground as in the conventional art, fine particles formed due to chipping will be oxidatively degraded to reduce the magnetic properties of the SmFeN-based magnetic powder. It is also considered that when the SmFeN-based magnetic powder containing fine particles is used to produce a SmFeN-based rare earth magnet, the fine particles cannot be sufficiently oriented during compaction in a magnetic field, resulting in a reduction in the magnetic properties of the SmFeN-based rare earth magnet. In contrast, when the SmFeN-based magnetic powder is dispersed as in the present embodiments, it is considered that as the resulting SmFeN-based magnetic powder contains few fine particles and aggregated particles, the SmFeN-based magnetic powder can be inhibited from having lower magnetic properties due to oxidative degradation of the fine particles; further, sufficient orientation can be achieved even during compaction in a magnetic field, resulting in a SmFeN-based rare earth magnet having higher magnetic properties.

The dispersion apparatus used in the dispersion step may be a vibration mill, for example. The media used in the dispersion apparatus such as vibration mill may be a resin-coated metal media. Examples of the metal material include iron, chromium steel, stainless steel, and steel. The media used in the dispersion apparatus such as vibration mill may also be a resin-coated ceramic media. Examples of the ceramic material include inorganic compounds such as oxides, carbides, nitrides, or borides of metals or non-metals, specific examples of which include alumina, silica, zirconia, silicon carbide, silicon nitride, barium titanate, and glass. Iron or chromium steel is preferred among these because they have a high dispersing ability owing to the high specific gravity and less wear owing to the high hardness, and also because the iron-containing wear powder generated by abrasion has a low impact on the SmFeN-based magnetic powder. In other words, a resin-coated iron media or a resin-coated chromium steel media is preferably used in the dispersion apparatus. Examples of the coating resin include thermoplastic resins such as nylon 6, nylon 66, nylon 12, polypropylene, polyphenylene sulfide, and polyethylene, and thermosetting resins such as epoxy resins and silicone resins, and combinations thereof. Thermoplastic resins can be formed by injection molding and the fluidity of thermoplastic resins is higher than the fluidity of thermosetting resins. Thus, the thickness of a coating using a thermoplastic resin can be thinner than that of a coating using a thermosetting resin. Therefore, a thermoplastic resin-coated media can have a higher specific gravity and a smaller size than those of a thermosetting resin-coated media. Nylon such as nylon 6, nylon 66, or nylon 12 is preferred among thermoplastic resins, because nylon is relatively soft and inexpensive among thermoplastic resins. For example, a nylon-coated iron media may be used in the dispersion apparatus. In this case, the SmFeN-based magnetic powder can be dispersed while further reducing the generation of fine particles.

The metal or ceramic media used in the dispersion step preferably has a specific gravity of at least 4, more preferably at least 5. If the specific gravity is less than 4, the impact energy during dispersion tends to be too small so that dispersion is less likely to occur. The upper limit of the specific gravity is not limited, but is preferably not more than 8, more preferably not more than 7.5. The media used in the dispersion step may have a specific gravity of at least 6 but not more than 7.5. The resin-coated metal media or resin-coated ceramic media can be described, in other words, as including a metal or ceramic core and a resin film coating the core. For example, the thickness of the resin film may be at least 0.1 μm but not more than 5 mm, which is suitable for dispersing the SmFeN-based magnetic powder because an increase in the diameter of the media can be reduced. Therefore, the resulting SmFeN-based magnetic powder can have an improved residual magnetization Gr.

Although the dispersion step may be performed in the presence of a solvent, it is preferably performed in the absence of a solvent in order to inhibit the oxidation of the SmFeN-based magnetic powder due to the components (e.g., moisture) in the solvent.

To inhibit oxidation of the SmFeN-based magnetic powder, the dispersion step is preferably performed in an inert gas atmosphere with an inert gas such as nitrogen gas or argon gas. When the inert gas atmosphere is a nitrogen gas atmosphere, the concentration of nitrogen in the nitrogen gas atmosphere may be 90% by volume or more, preferably 95% by volume or more. When the inert gas atmosphere is an argon gas atmosphere, the concentration of argon in the argon gas atmosphere may be 90% by volume or more, preferably 95% by volume or more. The inert gas atmosphere may be an atmosphere in which two or more inert gases such as nitrogen gas and argon gas are mixed. The concentration of the inert gas(es) in the inert gas atmosphere may be 90% by volume or more, preferably 95% by volume or more.

The diameter of the media is preferably at least 2 mm but not more than 100 mm, more preferably at least 3 mm but not more than 15 mm, still more preferably at least 3 mm but not more than 10 mm. A media having a diameter of less than 2 mm is difficult to coat with a resin, while a media having a diameter of more than 100 mm is large and thus tends to have less contact with the powder so that dispersion is less likely to occur.

When a vibration mill is used in the dispersion step, for example, the amount of the media may be at least 60% by volume but not more than 70% by volume, and the amount of the SmFeN-based magnetic powder may be at least 3% by volume but not more than 20% by volume, preferably at least 5% by volume but not more than 20% by volume, each relative to the volume of the container used to contain the SmFeN-based magnetic powder and the media.

The whole modifier powder containing Zn added does not have to coat the SmFeN-based magnetic powder. The modifier powder containing Zn may remain in the form of particles in the resulting rare earth magnetic powder.

The SmFeN-based magnetic powder used in the mixing step may be prepared with reference to the method disclosed in, for example, JP 2017-117937 A or JP 2021-055188 A. An exemplary method of producing the SmFeN-based magnetic powder will be described below.

The SmFeN-based magnetic powder used in the mixing step may be prepared by a production method including: pretreating an oxide containing Sm and Fe by heat-treatment in a reducing gas-containing atmosphere to obtain a partial oxide; heat-treating the partial oxide in the presence of a reducing agent to obtain alloy particles; nitriding the alloy particles to obtain a nitride; and washing the nitride to obtain the SmFeN-based magnetic powder. The SmFeN-based magnetic powder used in the mixing step may be a powder that has undergone a dispersion step. In other words, the method for producing the SmFeN-based magnetic powder used in the mixing step may include a dispersion step before mixing. The dispersion step before mixing may be performed in the same manner as described for the above-mentioned dispersion step.

Although the oxide containing Sm and Fe used in the pretreatment step may be prepared by mixing a Sm oxide and a Fe oxide, it can be prepared by mixing a solution containing Sm and Fe with a precipitant to obtain a precipitate containing Sm and Fe (precipitation step), and calcining the precipitate to obtain an oxide containing Sm and Fe (oxidation step).

### Precipitation Step

In the precipitation step, a Sm raw material and a Fe raw material may be dissolved in a strong acid solution to prepare a solution containing Sm and Fe. When the main phase to be obtained is Sm₂Fe₁₇N₃, the molar ratio of Sm and Fe (Sm:Fe) is preferably 1.5:17 to 3.0:17, more preferably 2.0:17 to 2.5:17. To the solution may be added a raw material such as La, W, Co, Ti, Sc, Y, Pr, Nd, Pm, Gd, Tb, Dy, Ho, Er, Tm, or Lu. In view of remanence, the solution preferably contains La. In view of coercive force and squareness ratio, the solution preferably contains W. In view of temperature characteristics, the solution preferably contains R, where R is at least one selected from the group consisting of Ti, Ba, and Sr.

Any Sm or Fe raw material soluble in a strong acid solution may be used. In view of availability, examples of the Sm raw material include samarium oxide, and examples of the Fe raw material include FeSO₄. The concentration of the solution containing Sm and Fe may be appropriately adjusted within a range in which the Sm raw material and the Fe raw material can be substantially dissolved in the acid solution. In view of solubility, examples of the acid solution include sulfuric acid.

The solution containing Sm and Fe may be reacted with a precipitant to obtain an insoluble precipitate containing Sm and Fe. Here, the solution containing Sm and Fe is not limited as long as Sm and Fe are present in the solution during the reaction with the precipitant. For example, a solution of a Sm raw material and a solution of a Fe raw material may be separately prepared and individually added dropwise to react with a precipitant. When separate solutions are prepared, the solutions may be appropriately adjusted within a range in which the respective raw materials can be substantially dissolved in the acid solution. The precipitant may be any alkaline solution that can react with a solution containing Sm and Fe to give a precipitate. Examples include ammonia water and caustic soda, with caustic soda being preferred.

To easily control the particle properties of the precipitate, the precipitation reaction is preferably carried out by dropwise adding the solution containing Sm and Fe and the precipitant each to a solvent such as water. A precipitate having a homogeneous element distribution, a narrow particle size distribution, and a uniform particle shape can be obtained by appropriately controlling the feeding rates of the solution containing Sm and Fe and the precipitant, the reaction temperature, the concentration of the reaction solution, the pH during the reaction, and other conditions. The use of such a precipitate improves the magnetic properties of the finally produced SmFeN-based magnetic powder. The reaction temperature is preferably at least 0° C. but not higher than 50° C., more preferably at least 35° C. but not higher than 45° C. The concentration of the reaction solution calculated as the total concentration of metal ions is preferably at least 0.65 mol/L but not more than 0.85 mol/L, more preferably at least 0.7 mol/L but not more than 0.85 mol/L. The reaction pH is preferably at least 5 but not more than 9, more preferably at least 6.5 but not more than 8.

In view of magnetic properties, the solution containing Sm and Fe preferably further contains at least one metal selected from the group consisting of La, W, and R, where R is at least one selected from the group consisting of Ti, Ba, and Sr. For example, in view of remanence, the solution preferably contains La. In view of coercive force and squareness ratio, the solution preferably contains W. In view of temperature characteristics, the solution preferably contains R. Any La raw material soluble in a strong acid solution may be used. In view of availability, examples include La₂O₃ and LaCl₃. The concentration may be appropriately adjusted within a range in which the Sm raw material and Fe raw material as well as the La, W, and/or R raw material can be substantially dissolved in the acid solution. In view of solubility, examples of the acid solution include sulfuric acid. Examples of the W raw material include ammonium tungstate, examples of the Co raw material include cobalt sulfate, and examples of the Ti raw material include sulfated titania.

When the solution containing Sm and Fe further contains at least one metal selected from the group consisting of La, W, and R, where R is at least one selected from the group consisting of Ti, Ba, and Sr, an insoluble precipitate containing Sm, Fe, and at least one selected from the group consisting of La, W, and R will be produced. Here, the solution is not limited as long as at least one selected from the group consisting of La, W, and R is present in the solution during the reaction with the precipitant. For example, solutions of the respective raw materials may be separately prepared and individually added dropwise to react with the precipitant. Alternatively, they may be prepared into the same solution containing Sm and Fe.

The powder obtained in the precipitation step roughly determines the powder particle size, particle shape, and particle size distribution of the finally produced SmFeN-based magnetic powder. When the particle size of the obtained powder is measured with a laser diffraction-type wet particle size distribution analyzer, the size and distribution of all the powder may preferably substantially fall within the range of at least 0.05 μm but not more than 20 μm, preferably at least 0.1 μm but not more than 10 μm.

After separating the precipitate, the separated precipitate is preferably subjected to solvent removal in order to reduce aggregation of the precipitate caused by evaporation of the residual solvent in which the precipitate has been re-dissolved during the heat-treatment in the subsequent oxidation step, and to reduce changes in properties such as particle size distribution and powder particle size. Specifically, for example, when the solvent used is water, the solvent removal may be carried out by drying in an oven at a temperature of at least 70° C. but not higher than 200° C. for at least 5 hours but not longer than 12 hours.

The precipitation step may be followed by separating and washing the resulting precipitate. The washing step may be appropriately performed until the conductivity of the supernatant solution reaches 5 mS/m² or lower. The step of separating the precipitate may be carried out, for example, by mixing the resulting precipitate with a solvent (preferably water), followed by filtration, decantation, or other separation methods.

### Oxidation Step

The oxidation step includes calcining the precipitate formed in the precipitation step to obtain an oxide containing Sm and Fe. For example, the precipitate may be converted into an oxide by heat-treatment. The heat-treatment of the precipitate needs to be performed in the presence of oxygen, for example in an air atmosphere. Moreover, since the presence of oxygen is necessary, the non-metal portion of the precipitate preferably contains an oxygen atom.

The heat-treatment temperature in the oxidation step (hereinafter, oxidation temperature) is not limited, but is preferably at least 700° C. but not higher than 1300° C., more preferably at least 900° C. but not higher than 1200° C. If the temperature is lower than 700° C., the oxidation tends to be insufficient. If the temperature is higher than 1300° C., the resulting SmFeN-based magnetic powder tends not to have the target particle shape, average particle size, and particle size distribution. The heat-treatment duration is not limited, either, but is preferably at least one hour but not longer than three hours.

The thus formed oxide is oxide particles in which Sm and Fe have been microscopically sufficiently mixed, and the shape, particle size distribution, and other properties of the precipitate have been reflected.

### Pretreatment Step

The pretreatment step includes heat-treating the oxide containing Sm and Fe in a reducing gas-containing atmosphere to obtain a partial oxide which is a partially reduced oxide.

Herein, the term “partial oxide” refers to a partially reduced oxide. The oxygen concentration of the partial oxide is not limited, but is preferably not more than 10% by mass, more preferably not more than 8% by mass. If the concentration is more than 10% by mass, the heat generated by reduction with Ca in the reduction step tends to increase, raising the calcination temperature to thus form abnormally grown particles. Here, the oxygen concentration of the partial oxide can be measured by non-dispersive infrared spectroscopy (ND-IR).

The reducing gas may be appropriately selected from, for example, hydrogen (H₂), carbon monoxide (CO), hydrocarbon gases such as methane (CH₄), and combinations thereof. Hydrogen gas is preferred in terms of cost. The flow rate of the gas may be appropriately adjusted within a range that does not cause scattering of the oxide. The heat-treatment temperature in the pretreatment step (hereinafter, pretreatment temperature) is preferably at least 300° C. but not higher than 950° C. The lower limit is more preferably at least 400° C., still more preferably at least 750° C. The upper limit is more preferably lower than 900° C. When the pretreatment temperature is at least 300° C., the oxide containing Sm and Fe can be efficiently reduced. When the pretreatment temperature is not higher than 950° C., the grain growth and segregation of the oxide particles can be inhibited so that the desired particle size can be maintained. The heat-treatment duration is not limited but may be at least one hour but not longer than 50 hours. Moreover, when the reducing gas used is hydrogen, preferably, the thickness of the oxide layer used is adjusted to not more than 20 mm, and further the dew point in the reaction furnace is adjusted to not higher than −10° C.

### Reduction Step

The reduction step includes heat-treating the partial oxide in the presence of a reducing agent to obtain alloy particles. For example, the reduction may be carried out by contacting the partial oxide with molten calcium or calcium vapor. In view of magnetic properties, the heat-treatment temperature is preferably at least 920° C. but not higher than 1200° C., more preferably at least 950° C. but not higher than 1150° C., still more preferably at least 980° C. but not higher than 1100° C.

As an alternative to the above-mentioned heat-treatment in the reduction step, heat-treatment may be performed at a first temperature of at least 1000° C. but not higher than 1090° C. and then at a second temperature lower than the first temperature of at least 980° C. but not higher than 1070° C. The first temperature is preferably at least 1010° C. but not higher than 1080° C., and the second temperature is preferably at least 990° C. but not higher than 1060° C. With regard to the difference between the first temperature and the second temperature, the second temperature is preferably lower than the first temperature by at least 15° C. but not more than 60° C., more preferably by at least 15° C. but not more than 30° C. The heat-treatment at the first temperature and the heat-treatment at the second temperature may be continuously performed. Although there may be a heat-treatment at a temperature lower than the second temperature between these heat-treatments, it is preferred in view of productivity to perform these heat-treatments continuously. To perform a more uniform reduction reaction, the duration of each heat-treatment is preferably shorter than 120 minutes, more preferably shorter than 90 minutes. The lower limit of the heat-treatment duration is preferably not shorter than 10 minutes, more preferably not shorter than 30 minutes.

As the reducing agent, metallic calcium may be used in the form of granules or powder, and its average particle size is preferably not more than 10 mm. This can more effectively inhibit aggregation during the reduction reaction. Moreover, the metallic calcium is preferably added in an amount that is 1.1 to 3.0 times, more preferably 1.5 to 2.5 times the reaction equivalent, which is the stoichiometric amount needed to reduce the rare earth oxide(s), and includes the amount needed to reduce an oxide of the Fe component, if present.

In the reduction step, a disintegration accelerator may optionally be used together with the reducing agent metallic calcium. The disintegration accelerator may be appropriately used to facilitate the disintegration or granulation of the product during the post treatment step described later. Examples include alkaline earth metal salts such as calcium chloride and alkaline earth oxides such as calcium oxide. Such a disintegration accelerator may be used in an amount of at least 1% by mass but not more than 30% by mass, preferably at least 5% by mass but not more than 30% by mass, relative to the amount of the samarium oxide.

### Nitridation Step

The nitridation step includes nitriding the alloy particles obtained in the reduction step to obtain anisotropic magnetic particles. As the particulate precipitate obtained in the precipitation step is used, the alloy particles obtained in the reduction step are in porous bulk form. This permits the alloy particles to be directly nitrided by heat-treatment in a nitrogen atmosphere without grinding, resulting in uniform nitridation.

The heat-treatment temperature in the nitridation of the alloy particles (hereinafter, nitridation temperature) is preferably 300 to 610° C., particularly preferably 400 to 550° C., and the atmosphere may be replaced with nitrogen to perform the heat-treatment in this temperature range. The heat-treatment duration may be selected so that the alloy particles can be sufficiently uniformly nitrided.

With regard to the heat-treatment temperature in the nitridation of the alloy particles, heat-treatment for nitridation may be performed at a first temperature of at least 400° C. but not higher than 470° C. and then at a second temperature of at least 480° C. but not higher than 610° C. If the alloy particles are heat-treated at the high second temperature without being nitrided at the first temperature, the nitridation may rapidly proceed to cause abnormal heat generation which can degrade the SmFeN-based magnetic powder, greatly reducing the magnetic properties. Moreover, the nitridation step is preferably performed in a substantially nitrogen atmosphere in order to allow the nitridation to proceed more slowly.

Here, the term “substantially” is used in consideration of the potential presence of unavoidable element(s) other than nitrogen due to contamination of impurities or other factors. For example, the nitrogen content of the atmosphere is not lower than 95%, preferably not lower than 97%, more preferably not lower than 99%.

The first temperature in the nitridation step is preferably at least 400° C. but not higher than 470° C., more preferably at least 410° C. but not higher than 450° C. If the first temperature is lower than 400° C., the nitridation tends to proceed very slowly. If the first temperature is higher than 470° C., excessive nitridation or degradation tends to easily occur due to heat generation. The heat-treatment duration at the first temperature is not limited but is preferably at least one hour but not longer than 40 hours, more preferably not longer than 20 hours. If the heat-treatment duration is shorter than one hour, the nitridation may insufficiently proceed. If the heat-treatment duration is longer than 40 hours, productivity is impaired.

The second temperature is preferably at least 480° C. but not higher than 610° C., more preferably at least 500° C. but not higher than 550° C. If the second temperature is lower than 480° C., the nitridation of large particles may insufficiently proceed. If the second temperature is higher than 610° C., excessive nitridation or degradation can easily occur. The heat-treatment duration at the second temperature is preferably at least 15 minutes but not longer than 5 hours, more preferably at least 30 minutes but not longer than 2 hours. If the heat-treatment duration is shorter than 15 minutes, the nitridation may insufficiently proceed. If the heat-treatment duration is longer than 5 hours, productivity is impaired.

The heat-treatment at the first temperature and the heat-treatment at the second temperature may be continuously performed. Although there may be a heat-treatment at a temperature lower than the second temperature between these heat-treatments, it is preferred in view of productivity to perform these heat-treatments continuously.

### Post Treatment Step

The product obtained after the nitridation step may contain, in addition to the magnetic particles, materials such as by-product CaO and unreacted metallic calcium, which may be combined into sintered bulk form. Such a product obtained after the nitridation step may be introduced into cold water to separate the CaO and metallic calcium as a suspension of calcium hydroxide (Ca(OH)₂) from the SmFeN-based magnetic powder. Further, the residual calcium hydroxide may be sufficiently removed by washing the SmFeN-based magnetic powder with acetic acid or the like. When the product is introduced into water, oxidation of metallic calcium by water and hydration of by-product CaO will occur, causing disintegration or micronization of the reaction product that has been combined into sintered bulk form.

### Alkali Treatment Step

The product obtained after the nitridation step may be introduced into an alkali solution. Examples of the alkali solution used in the alkali treatment step include an aqueous calcium hydroxide solution, an aqueous sodium hydroxide solution, and an aqueous ammonia solution. In view of wastewater treatment and high pH, an aqueous calcium hydroxide solution or an aqueous sodium hydroxide solution is preferred among these. In the alkali treatment of the product obtained after the nitridation step, the remaining Sm-rich layer containing a certain amount of oxygen serves as a protection layer, thereby reducing an increase in oxygen concentration caused by the alkali treatment.

The pH of the alkali solution used in the alkali treatment step is not limited, but is preferably not less than 9, more preferably not less than 10. If the pH is less than 9, the rate of the reaction into calcium hydroxide is high, causing greater heat generation. Thus, the finally produced SmFeN-based magnetic powder tends to have a higher oxygen concentration.

In the alkali treatment step, the SmFeN-based magnetic powder obtained after the treatment with an alkali solution may optionally be subjected to decantation or other techniques to reduce the moisture.

### Acid Treatment Step

The post treatment step or the alkali treatment step may further be followed by treatment with an acid. In the acid treatment step, the aforementioned Sm-rich layer may be at least partially removed to reduce the oxygen concentration of the magnetic powder as a whole. Moreover, since the production method according to the present embodiments does not include grinding or the like, the SmFeN-based magnetic powder has a small average particle size and a narrow particle size distribution, and also does not contain fine particles formed by grinding or the like, which makes it possible to reduce an increase in oxygen concentration.

Any acid may be used in the acid treatment step, and examples include hydrogen chloride, nitric acid, sulfuric acid, and acetic acid. To avoid residual impurities, hydrogen chloride or nitric acid is preferred among these.

The amount of the acid used in the acid treatment step per 100 parts by mass of the SmFeN-based magnetic powder is preferably at least 3.5 parts by mass but not more than 13.5 parts by mass, more preferably at least 4 parts by mass but not more than 10 parts by mass. If the amount is less than 3.5 parts by mass, the oxide tends to remain on the surface of the SmFeN-based magnetic powder, resulting in a higher oxygen concentration. If the amount is more than 13.5 parts by mass, reoxidation is more likely to occur upon exposure to the air, and the cost also tends to increase because the acid dissolves the SmFeN-based magnetic powder. When the amount of the acid is at least 3.5 parts by mass but not more than 13.5 parts by mass per 100 parts by mass of the SmFeN-based magnetic powder, the surface of the SmFeN-based magnetic powder can be coated with the Sm-rich layer oxidized enough to inhibit reoxidation upon exposure to the air after the acid treatment. Thus, the resulting SmFeN-based magnetic powder has a low oxygen concentration, a small average particle size, and a narrow particle size distribution.

In the acid treatment step, the SmFeN-based magnetic powder obtained after the treatment with an acid may optionally be subjected to decantation or other techniques to reduce the moisture.

### Dehydration Step

The acid treatment step is preferably followed by dehydration. The dehydration can reduce the moisture in the solids before vacuum drying, thereby inhibiting the progress of oxidation during drying caused due to the higher moisture content of the solids before vacuum drying. Here, the term “dehydration” refers to a treatment in which a pressure or a centrifugal force is applied to reduce the moisture content of the solids after the treatment as compared to that of the solids before the treatment, and excludes mere decantation, filtration, or drying. The dehydration may be carried out by any method such as squeezing or centrifugation.

The moisture content of the SmFeN-based magnetic powder after the dehydration is not limited, but in order to inhibit the progress of oxidation, it is preferably not more than 13% by mass, more preferably not more than 10% by mass.

The SmFeN-based magnetic powder obtained by acid treatment or the SmFeN-based magnetic powder obtained by acid treatment followed by dehydration is preferably dried in vacuum. The drying temperature is not limited, but is preferably not lower than 70° C., more preferably not lower than 75° C. The drying duration is not limited, either, but is preferably not shorter than one hour, more preferably not shorter than three hours.

### Phosphate Treatment Step

The post treatment step, the alkali treatment step, or the acid treatment step may be followed by phosphate treatment of the rare earth magnetic powder. The phosphate treatment of the rare earth magnetic powder results in the formation of a passive film having a P—O bond on the surface of the rare earth magnetic powder. Coating the rare earth magnetic powder with a film containing P and O can reduce oxidative degradation due to the air during processing, and can reduce oxidative degradation during molding of a bonded magnet (e.g., when a PPS resin with SO₄ at the end is used, the molding temperature is as high as 340° C.).

In the phosphate treatment step, a phosphate treatment agent and the rare earth magnetic powder may be reacted. Examples of the phosphate treatment agent include orthophosphoric acid, sodium dihydrogen phosphate, potassium dihydrogen phosphate, ammonium dihydrogen phosphate, diammonium hydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. Such a phosphate source may basically be dissolved in water or an organic solvent such as IPA, optionally supplemented with a reaction accelerator such as nitrate ions or a grain refiner such as V ions, Cr ions, or Mo ions, and the rare earth magnetic powder may be introduced into the resulting phosphate bath to form a passive film having a P—O bond on the surface of the magnetic powder.

After the phosphate treatment, drying is preferably performed under a normal pressure or in vacuum. The use of not only phosphate coating but also chemical bonding by drying improves the coercive force. Moreover, the chemical bonding of phosphorus by drying can inhibit the formation of ZnO from the Zn in the modifier powder in the step of heat-treating the SmFeN-based magnetic powder. The drying temperature is preferably not lower than 140° C.

A rare earth magnetic powder according to the present embodiments is a SmFeN-based rare earth magnetic powder containing Sm, Fe, and N, the rare earth magnetic powder containing at least 6% by mass but not more than 10% by mass of Zn based on the total amount of the rare earth magnetic powder, and having a particle size D50 corresponding to the 50th percentile of the cumulative particle size distribution by volume of the rare earth magnetic powder of at least 1 μm but not more than 4 μm, a residual magnetization σr of not less than 120 emu/g, and a squareness ratio Hk of not less than 13000 Oe. The rare earth magnetic powder can be produced by, for example, the method of producing a rare earth magnetic powder of the present embodiments described above. Here, the SmFeN-based rare earth magnetic powder may be anisotropic.

The SmFeN-based rare earth magnetic powder containing Sm, Fe, and N is as described above. In addition to Sm, Fe, and N, the rare earth magnetic powder preferably contains La, W, and R, where R is at least one selected from the group consisting of Ti, Ba, and Sr, as described above.

Although the Zn content may be at least 6% by mass but not more than 10% by mass, it is preferably at least 8% by mass but not more than 10% by mass. If the Zn content is less than 6% by mass, the improvements in coercive force and squareness ratio tend to be reduced due to the smaller amount of Zn coating the SmFeN-based magnetic powder. If the Zn content is more than 10% by mass, the magnetization tends to be reduced due to the excessive amount of Zn coating the SmFeN-based magnetic powder.

The average particle size of the SmFeN-based rare earth magnetic powder is preferably at least 2.5 μm but not more than 5 more preferably at least 2.6 μm but not more than 4.5 μm. An average particle size of less than 2.5 μm tends to facilitate oxidization due to the large surface area. A SmFeN-based magnetic powder having an average particle size of more than 5 μm tends to show a multidomain structure and thus have lower magnetic properties.

The particle size D10 of the SmFeN-based rare earth magnetic powder is preferably at least 0.5 μm but not more than 3 more preferably at least 1 μm but not more than 2 When the SmFeN-based magnetic powder is used as a bonded magnet, if the D10 is less than 0.5 the amount of the SmFeN-based magnetic powder filled in the bonded magnet tends to decrease, resulting in lower magnetization. If the D10 is more than 3 the coercive force of the bonded magnet tends to decrease. Herein, the D10 is defined as the particle size corresponding to the 10th percentile of the cumulative particle size distribution by volume of the SmFeN-based magnetic powder.

The particle size D50 of the SmFeN-based rare earth magnetic powder is at least 1 μm but not more than 4 preferably at least 1.5 μm but not more than 3.5 μm, more preferably at least 2 μm but not more than 3.5 μm. D50 of less than 1 μm may facilitate oxidization due to the large surface area. A SmFeN-based magnetic powder having a D50 of more than 4 μm may show a multidomain structure and thus have lower magnetic properties. Herein, the particle size is measured using a laser diffraction particle size distribution analyzer under dry conditions, and the D50 is defined as the particle size corresponding to the 50th percentile of the cumulative particle size distribution by volume of the SmFeN-based magnetic powder.

The particle size D90 of the SmFeN-based rare earth magnetic powder is preferably at least 3 μm but not more than 7 more preferably at least 4.5 μm but not more than 6.5 When the SmFeN-based magnetic powder is used as a bonded magnet, if the D90 is less than 3 the amount of the SmFeN-based magnetic powder filled in the bonded magnet tends to decrease, resulting in lower magnetization. If the D90 is more than 7 the coercive force of the bonded magnet tends to decrease. Herein, the D90 is defined as the particle size corresponding to the 90th percentile of the cumulative particle size distribution by volume of the SmFeN-based magnetic powder.

The average particle size, D10, D50, and D90 are measured using a laser diffraction particle size distribution analyzer under dry conditions.

The SmFeN-based rare earth magnetic powder preferably has a below-defined span of not more than 1.6, more preferably not more than 1.5, still more preferably not more than 1.4.

Span=(D90−D10)/D50

In the equation, D10, D50, and D90 represent the particle sizes corresponding to the 10th percentile, 50th percentile, and 90th percentile, respectively, of the cumulative particle size distribution by volume. If the span is more than 1.6, the magnetic properties tend to decrease due to the presence of large particles.

The average circularity of the SmFeN-based rare earth magnetic powder is preferably not less than 0.50, more preferably not less than 0.70, particularly preferably not less than 0.75. If the circularity is less than 0.50, the fluidity may deteriorate so that stress can occur between the particles during the magnetic field compaction, resulting in lower magnetic properties. The circularity can be measured using a scanning electron microscope (SEM) and a particle analysis Ver. 3 available from Sumitomo Metal Technology, Inc. as image analysis software. The circularity may be determined by taking a SEM image at a magnification of 3000, processing the image for binarization, and calculating the circularity of each particle. The term “circularity” defined in the present disclosure refers to the average of the circularities determined by measuring about 1,000 to 10,000 particles. In general, the larger the number of small size particles, the higher the circularity. Hence, particles having a particle size of not less than 1 μm are measured for circularity. The circularity measurement uses the definitional equation: Circularity=4πS/L², wherein S represents the area of the two-dimensional projection of the particle, and L represents the perimeter of the two-dimensional projection thereof.

The residual magnetization σr is not less than 120 emu/g, preferably not less than 125 emu/g.

The squareness ratio Hk is not less than 13000 Oe, preferably not less than 15000 Oe. Here, the squareness ratio Hk refers to the magnetic field which corresponds to 90% of the remanence on the demagnetization curve.

The coercive force iHc is preferably not less than 25000 Oe, more preferably not less than 28000 Oe.

The rare earth magnetic powder according to the present embodiments preferably includes a main phase containing Sm, Fe, and N, and a coating layer coating the main phase. The coating layer may contain Zn localized on the main phase side. The coating layer may include a Zn-containing region and a P-containing region located outwardly from the Zn-containing region.

Such a rare earth magnetic powder in a unique form can be produced by, for example, the method of producing a rare earth magnetic powder according to the present embodiments described above. When a phosphate-treated SmFeN-based magnetic powder and a modifier powder containing Zn are mixed and heat-treated, a P-containing region formed by the phosphate treatment and a Zn-containing region are provided as the coating layer of the SmFeN-based magnetic powder, resulting in a unique structure in which the P-containing region formed by the phosphate treatment is located outwardly from the Zn-containing region. It is believed that the heat-treatment may allow the Zn in the modifier to penetrate through the P-containing region and react with the Fe in the SmFeN-based magnetic powder to form a Fe—Zn alloy layer.

The thickness of the Zn-containing region is not limited, but is preferably at least 1 nm but not more than 100 nm, more preferably at least 5 nm but not more than 50 nm. The thickness of the P-containing region is not limited, but is preferably at least 1 nm but not more than 50 nm, more preferably at least 5 nm but not more than 30 nm.

The SmFeN-based magnetic powder according to the present embodiments is typically represented by the following formula:

SmᵥFe_{(100-v-w-x-y-z)}N_{w}LaₓW_{y}R_{z}

wherein 3≤v≤30, 3≤w≤15, 0≤x≤0.5, 0≤y≤2.5, and 0≤z≤0.3.

In the formula, v is defined to be at least 3 but not more than 30 for the following reason. If v is less than 3, the unreacted iron component (α-Fe phase) may be separated, which reduces the coercive force of the SmFeN-based magnetic powder so as to fail to provide a practical magnet, while if v is more than 30, the Sm element may precipitate and make the SmFeN-based magnetic powder unstable in the air, thereby reducing the remanence. Moreover, w is defined to be at least 3 but not more than 15 for the following reason. If w is less than 3, almost no coercive force may be obtained, while if w is more than 15, a nitride of Sm or iron itself may be formed. The x is at least 0 but not more than 0.5, preferably at least 0.05 but not more than 0.5. If x is less than 0.05, the effect of the addition may be insufficient, while if x is more than 0.5, a nitride of Sm or iron itself may be formed, greatly reducing the magnetization. The y is at least 0 but not more than 2.5, preferably at least 0.05 but not more than 2.5. If y is less than 0.05, the effect of the addition may be insufficient, while if y is more than 2.5, a nitride of Sm or iron itself may be formed, greatly reducing the magnetization. The z is at least 0 but not more than 0.3, preferably at least 0.0001 but not more than 0.3. If z is less than 0.0001, the effect of the addition may be insufficient, while if z is more than 0.3, a nitride of Sm or iron itself may be formed, greatly reducing the magnetization.

In view of remanence, the La content is preferably at least 0.1% by mass but not more than 5% by mass, more preferably at least 0.15% by mass but not more than 1% by mass.

In view of coercive force, the W content is preferably at least 0.1% by mass but not more than 5% by mass, more preferably at least 0.15% by mass but not more than 1% by mass.

In view of temperature characteristics, the R content is preferably not more than 1.0% by mass, more preferably not more than 0.5% by mass.

The N content is preferably at least 3.3% by mass but not more than 3.5% by mass. If the N content is more than 3.5% by mass, excessive nitridation may occur. If the N content is less than 3.3% by mass, insufficient nitridation may occur. In both cases, the magnetic properties tend to be lowered.

The rare earth magnetic powder according to the present embodiments has a high residual magnetization and a high squareness ratio Hk and thus is usable as a sintered magnet or a bonded magnet, for example. Among these, the rare earth magnetic powder is more suitable as a sintered magnet because the residual magnetization σr, coercive force iHc, and squareness ratio Hk of the rare earth magnetic powder are high, and the Zn functions as a binder, eliminating the need for compounding with a separate metal binder.

A bonded magnet may be prepared from the rare earth magnetic powder according to the present embodiments and a resin. The bonded magnet containing the rare earth magnetic powder exhibits high magnetic properties.

The resin contained in the bonded magnet may be a thermosetting resin or a thermoplastic resin, preferably a thermoplastic resin. Specific examples of the thermoplastic resin include polyphenylene sulfide resins (PPS), polyether ether ketones (PEEK), liquid crystal polymers (LCP), polyamides (PA), polypropylenes (PP), and polyethylenes (PE). The mass ratio (resin/rare earth magnetic powder) of the resin to the rare earth magnetic powder used in the bonded magnet preferably ranges from 0.10 to 0.15, more preferably from 0.11 to 0.14.

The rare earth magnetic powder and resin may be mixed at 280 to 330° C., e.g., using a kneader. The resulting composition may be heat-treated while applying an orientation field to align the easy axes of magnetization (orientation step), followed by pulse magnetization in a magnetizing field (magnetization step) to produce a bonded magnet.

The heat-treatment temperature in the orientation step is preferably, for example, 90 to 200° C., more preferably 100 to 150° C. The magnitude of the orientation field in the orientation step may be, for example, 720 kA/m, while the magnitude of the magnetizing field in the magnetization step may be, for example, 1500 to 2500 kA/m.

For example, a sintered magnet may be prepared by sintering the SmFeN-based magnetic powder in an atmosphere with an oxygen concentration of not more than 0.5 ppm by volume at a temperature of higher than 300° C. but lower than 600° C. under a pressure of at least 1000 MPa but not more than 1500 MPa, as described in JP 2017-055072 A.

For example, a sintered magnet may be prepared by pre-compacting the SmFeN-based magnetic powder in a magnetic field of not lower than 6 kOe, followed by warm compaction at a temperature of not higher than 600° C. and a contact pressure of 1 to 5 GPa, as described in WO 2015/199096.

For example, a sintered magnet may be prepared by cold compaction at a contact pressure of 1 to 5 GPa, followed by heating at a temperature of 350 to 600° C. for 1 to 120 minutes, as described in JP 2016-082175 A. In this publication, a mixture containing a SmFeN-based magnetic powder and a metal binder is used; in contrast, the rare earth magnetic powder of the present embodiments containing Zn can be used to prepare a sintered magnet under the aforementioned conditions without using a metal binder.

### EXAMPLES

Examples are described below. It should be noted that “%” is by mass unless otherwise specified.

### Evaluation

The metal contents, average particle size, particle size distribution, nitrogen content, oxygen content, and residual magnetization σr of the SmFeN-based magnetic powders were evaluated by the following methods.

### Metal Contents

The Zn content of each SmFeN-based rare earth magnetic powder dissolved in hydrochloric acid was measured by ICP-AES (apparatus name: Optima 8300).

### Average Particle Size and Particle Size Distribution

The average particle size and particle size distribution of each SmFeN-based magnetic powder were measured with a laser diffraction particle size distribution analyzer (HELOS & RODOS available from Japan Laser Corporation).

Residual Magnetization σr, Coercive Force iHc, and Squareness Ratio Hk

Each prepared SmFeN-based rare earth magnetic powder was packed together with a paraffin wax into a sample vessel. After the paraffin wax was melted using a dryer, the easy axes of magnetization were aligned in an orientation field of 16 kA/m. The magnetically oriented sample was pulse-magnetized in a magnetizing field of 32 kA/m, and the residual magnetization σr, coercive force iHc, and squareness ratio Hk of the sample were measured using a vibrating sample magnetometer (VSM) with a maximum field of 16 kA/m. Here, the squareness ratio Hk refers to the magnetic field which corresponds to 90% of the remanence on the demagnetization curve.

### STEM-EDX Mapping

The rare earth magnetic powder prepared in Example 10 was dispersed in an epoxy resin and solidified, and then cross-sectioned with a cross-section polisher to obtain a cross-section sample for measurement. A STEM image (acceleration voltage: 200 kV) of the sample was measured using a scanning transmission electron microscope (STEM; available from JEOL Ltd.) and an energy dispersive X-ray analyzer (EDX; available from JEOL Ltd.).

### Production Example 1

### Precipitation Step

An amount of 5.0 kg of FeSO₄·7H₂O was mixed and dissolved in 2.0 kg of pure water. To the mixture were further added 0.49 kg of Sm₂O₃, 0.035 kg of La₂O₃, 0.006 kg of titanium oxide, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLaTi sulfuric acid solution.

The entire amount of the prepared SmFeLaTi sulfuric acid solution was added dropwise to 20 kg of pure water kept at a temperature of 40° C. with stirring over 70 minutes from the start of the reaction, while simultaneously adding dropwise 0.190 kg of a 13% by mass ammonium tungstate solution and a 15% by mass ammonia solution to adjust the pH to 7 to 8. Thus, a slurry containing a SmFeLaWTi hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was calcined in the air at 1000° C. for one hour. After cooling, a red SmFeLaWTi oxide was obtained as a raw material powder.

### Pretreatment Step

An amount of 100 g of the SmFeLaWTi oxide was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by non-dispersive infrared spectroscopy (ND-IR) (EMGA-820 available from Horiba, Ltd.) and found to be 5% by mass. The results show that a black partial oxide was obtained in which the oxygen bonded to Sm remained unreduced and 95% of the oxygen bonded to Fe was reduced.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced into the furnace. The temperature was increased to 1060° C. and maintained for 45 minutes to obtain SmFeLaWTi alloy particles.

### Nitridation Step

Subsequently, the temperature inside the furnace was lowered to 100° C., followed by vacuum evacuation. Then, while introducing nitrogen gas, the temperature was increased to a first temperature of 430° C. and maintained for three hours. Next, the temperature was increased to a second temperature of 520° C. and maintained for one hour, followed by cooling to obtain a magnetic particle-containing bulk product.

### Post Treatment Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice. After solid-liquid separation, vacuum drying was performed at 80° C. for three hours to obtain a powder.

### Acid Treatment Step

To 100 parts by mass of the powder obtained in the post treatment step was added a 6% aqueous hydrochloric acid solution in an amount equivalent to 4.3 parts by mass of hydrogen chloride, and the mixture was stirred for one minute. After standing still, the supernatant was drained by decantation. The introduction into pure water, stirring, and decantation were repeated twice. After solid-liquid separation, vacuum drying was performed at 80° C. for three hours to obtain an acid-treated powder.

### Dispersion Step Before Mixing

The powder acid-treated in the acid treatment step and media (nylon-coated iron core media, diameter: 10 mm, Vickers number of nylon coating: 7, specific gravity: 7.48, thickness of nylon layer: about 1 to 3 mm) were put into a container used in a vibration mill so that the amounts of the powder and the media were 5% by volume and 60% by volume, respectively, relative to the volume of the container. The powder was dispersed by the vibration mill in a nitrogen atmosphere for 30 minutes to obtain a SmFeN-based anisotropic magnetic powder. The Sm, Fe, La, W, Ti, and N contents of the SmFeN-based anisotropic magnetic powder were 22.3% by mass, 71.5% by mass, 0.48% by mass, 0.64% by mass, 0.13% by mass, and 3.3% by mass, respectively.

### Production Example 2

A SmFeN-based anisotropic magnetic powder of Production Example 2 was obtained as in Production Example 1, except that the dispersion step before mixing was not performed.

### Production Example 3 (Phosphate-Treated Magnetic Powder)

The same process up to the dispersion step before mixing as in Production Example 1 was performed, followed by performing a surface treatment step to obtain a SmFeN-based anisotropic magnetic powder of Production Example 3.

### Surface Treatment Step

The magnetic powder obtained in the dispersion step before mixing was introduced into 3 kg of pure water and stirred for 30 minutes. After standing still, the supernatant was drained by decantation. The introduction into pure water, stirring, and decantation were repeated twice to obtain a slurry. Into the slurry was introduced a phosphate solution in an amount, calculated as PO₄, of 1 wt % of the solid content of the magnetic particles. The mixture was stirred for five minutes, followed by solid-liquid separation and then vacuum drying at 190° C. for three hours to obtain the phosphate-treated SmFeN-based anisotropic magnetic powder of Production Example 3.

### Examples 1 to 11

### Mixing Step and Heat-Treatment Step

An amount of 184 g of each of the magnetic powders prepared in Production Examples 1 to 3 and 16 g of metallic zinc powder were used and mixed using a vibration mill to obtain a powder mixture. The powder mixture was heat-treated using a vertical furnace under the heat-treatment conditions shown in Table 1. Here, the D50 and purity of the metallic zinc powder used were 0.5 μm and 99.9% by mass, respectively.

It should be noted that the heat-treatment was performed in two stages in Examples 3 to 6 and 11.

### Dispersion Step

The heat-treated SmFeN-based anisotropic magnetic powder and media (nylon-coated iron core media, diameter: 10 mm, Vickers number of nylon coating: 7, specific gravity: 7.48, thickness of nylon layer: about 1 to 3 mm) were put into a container used in a vibration mill so that the amounts of the SmFeN-based anisotropic magnetic powder and the media were 5% by volume and 60% by volume, respectively, relative to the volume of the container. The powder was dispersed by the vibration mill in a nitrogen atmosphere for 30 minutes to obtain a rare earth magnetic powder.

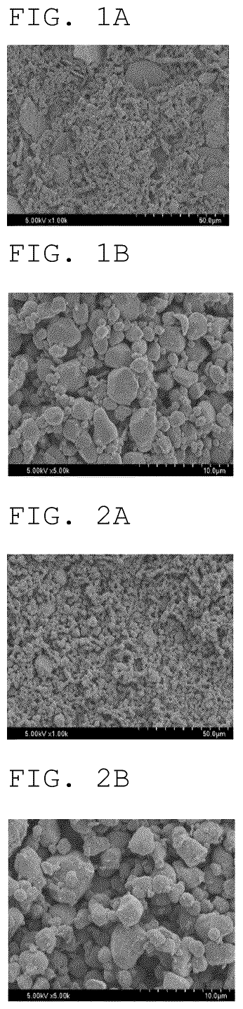

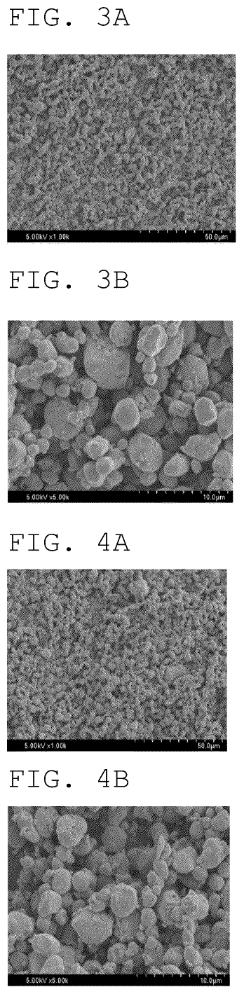

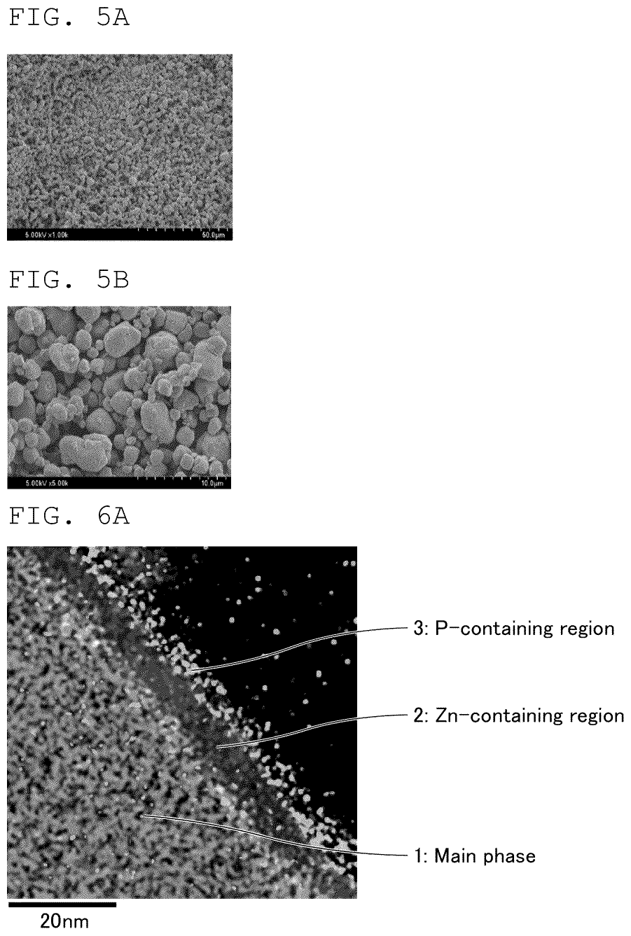

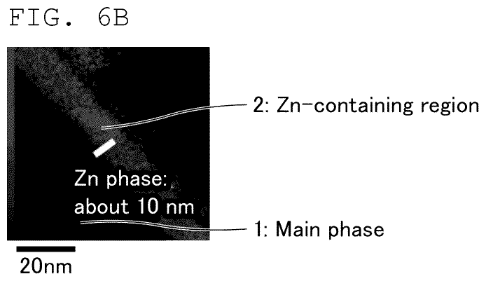

Table 1 shows the average particle size, particle size distribution, residual magnetization σr, coercive force iHc, and squareness ratio Hk of the thus-prepared rare earth magnetic powders measured by the above-described methods, and the analyzed Zn value thereof. Moreover, the rare earth magnetic powders prepared in Examples 3, 6, 9, and 11 were photographed using a scanning electron microscope (SU3500, Hitachi High-Tech Corporation, 5 kV, 5000×). The results are shown in FIG. 2A to FIG. 5B. Moreover, the powder mixture obtained by the mixing step in Example 3 was photographed using a scanning electron microscope (SU3500, Hitachi High-Tech Corporation, 5 kV, 5000×). The results are shown in FIG. 1A and FIG. 1B.

### Reference Examples 1 to 3

The magnetic powders prepared in Production Examples 1 to 3 were used as rare earth magnetic powders of Reference Examples 1 to 3, respectively. The residual magnetization σr, coercive force iHc, and squareness ratio Hk of the rare earth magnetic powders of Reference Examples 1 to 3 were measured by the above-described methods, and the results are shown in Table 2.

### Reference Example 4

A rare earth magnetic powder of Reference Example 4 was obtained as in Example 11, except that chromium steel balls (SUJ2, diameter: 2.3 mm, Vickers number: 760, specific gravity: 7.77) were used as the media. Table 3 shows the residual magnetization σr, coercive force iHc, and squareness ratio Hk of the rare earth magnetic powder measured by the above-described methods, and the analyzed Zn value thereof.

TABLE 1

| | | Heat-treatment step | | | | | | | After |
|---|---|---|---|---|---|---|---|---|---|
| | | Temper- | | Temper- | | Before dispersion | | | dispersion |
| Example | Magnetic | ature | Duration | ature | Duration | σr | iHc | Hk | σr |
| No. | powder | (° C.) | (min) | (° C.) | (hr) | (emu/g) | (0e) | (0e) | (emu/g) |
| 1 | Production | — | — | 400 | 20 | 103.30 | 27078 | 11890 | 124.6 |
| 2 | Example 1 | — | — | 420 | 20 | 99.23 | 34252 | 13500 | 126.5 |
| 3 | | 420 | 5 | 400 | 18 | 95.30 | 29216 | 11850 | 125.9 |
| 4 | | 440 | 5 | 420 | 18 | 92.18 | 36437 | 12430 | 124.1 |
| 5 | Production | 440 | 5 | 420 | 18 | 92.79 | 37482 | 13740 | 122.8 |
| 6 | Example 2 | 420 | 5 | 400 | 18 | 103.30 | 35819 | 13690 | 126.8 |
| 7 | | — | — | 400 | 20 | 98.04 | 35677 | 12780 | 126.5 |
| 8 | | — | — | 420 | 20 | 102.10 | 38290 | 14650 | 126.2 |
| 9 | Production | — | — | 400 | 20 | 103.80 | 25986 | 12450 | 124.0 |
| 10 | Example 3 | — | — | 420 | 20 | 104.40 | 24798 | 12080 | 124.1 |
| 11 | | 480 | 5 | 460 | 18 | 87.04 | 31354 | 11490 | 123.6 |
| | | After dispersion | | | | | | | |
| | | | | Zn | | | | Average | |
| | Example | iHc | Hk | content | D10 | D50 | D90 | particle | |
| | No. | (0e) | (0e) | (%) | (μm) | (μm) | (μm) | size (μm) | Span *) |
| | 1 | 23373 | 12580 | | 0.93 | 2.75 | 4.72 | 2.82 | 1.38 |
| | 2 | 29644 | 14870 | | | | | | |
| | 3 | 26081 | 15360 | 7.4 | 1.39 | 2.94 | 4.90 | 3.09 | 1.19 |
| | 4 | 31164 | 15670 | 7.5 | 1.41 | 2.91 | 4.80 | 3.04 | 1.16 |
| | 5 | 27933 | 16110 | 7.4 | 1.04 | 2.88 | 4.91 | 2.99 | 1.34 |
| | 6 | 23848 | 15100 | 7.9 | | | | | |
| | 7 | 24323 | 15590 | | | | | | |
| | 8 | 26793 | 16200 | | | | | | |
| | 9 | 23135 | 13560 | 7.8 | | | | | |
| | 10 | 23753 | 13400 | 7.5 | | | | | |
| | 11 | 32589 | 15020 | 7.4 | 1.26 | 2.87 | 4.79 | 2.97 | 1.23 |

*) Span (D90 − D10)/D50

TABLE 2

| Reference | Magnetic | σr | iHc | Hk |
|---|---|---|---|---|
| Example No. | powder | (em u/g) | (0e) | (0e) |
| 1 | Production | 153.4 | 8709 | 5244 |
| | Example 1 | | | |
| 2 | Production | 140.8 | 6329 | 2790 |
| | Example 2 | | | |
| 3 | Production | 148.3 | 17740 | 11330 |
| | Example 3 | | | |

TABLE 3

| | | Heat-treatment step | | | | After dispersion | | | |
|---|---|---|---|---|---|---|---|---|---|
| Reference | | Temper- | | Temper- | | | | | Zn |
| Example | Magnetic | ature | Duration | ature | Duration | σr | iHc | Hk | content |
| No. | powder | (° C.) | (min) | (° C.) | (hr) | (emu/g) | (0e) | (0e) | (%) |
| 4 | Production | 480 | 5 | 460 | 18 | 125.6 | 20665 | 10780 | 7.1 |
| | Example 3 | | | | | | | | |

In the SEM images of the rare earth magnetic powders prepared in Examples 3, 6, 9, and 11 shown in FIG. 2A to FIG. 5B, some large particles with a size of 10 μm or more were present. The particles are Zn particles remaining without coating the magnetic powder. The number and size of Zn particles were reduced in all the SEM images shown in FIG. 2A to FIG. 5B as compared to those of the powder mixture shown in FIG. 1A and FIG. 1B.

FIG. 6A and FIG. 6B show photographs of the results of STEM-EDX mapping analysis of the rare earth magnetic powder prepared in Example 11, in which a P-containing region is located outwardly from a Zn-containing region. The thickness of the Zn-containing region was about 10 nm.

What is claimed is:

1. A method of producing a rare earth magnetic powder, the method comprising:
heat-treating a mixture comprising a SmFeN-based magnetic powder containing Sm, Fe, and N and a modifier powder containing Zn; and
dispersing the heat-treated SmFeN-based magnetic powder using a resin-coated metal media or a resin-coated ceramic media.

2. The method of producing a rare earth magnetic powder according to claim 1,
wherein the dispersing is performed in the absence of a solvent.

3. The method of producing a rare earth magnetic powder according to claim 1,
wherein a specific gravity of the resin-coated metal media or the resin-coated ceramic media is not less than 4.

4. The method of producing a rare earth magnetic powder according to claim 1,
wherein in the heat-treating, the mixture comprising the SmFeN-based magnetic powder and the modifier powder is heat-treated at a first temperature and then at a second temperature lower than the first temperature.

5. The method of producing a rare earth magnetic powder according to claim 1,
wherein in the heat-treating, the SmFeN-based magnetic powder further contains La, W, and R, wherein R is at least one selected from the group consisting of Ti, Ba, and Sr.

6. The method of producing a rare earth magnetic powder according to claim 5, further comprising:
Pretreating by heat-treatment in a reducing-gas-containing atmosphere an oxide containing Sm, Fe, La, W, and R, wherein R is at least one selected from the group consisting of Ti, Ba, and Sr, to obtain a partial oxide;
heat-treating the partial oxide in the presence of a reducing agent to obtain alloy particles;
nitriding the alloy particles to obtain a nitride; and
washing the nitride to obtain the SmFeN-based magnetic powder to be used in the heat-treating of the mixture comprising the SmFeN-based magnetic powder and the modifier powder containing Zn.

7. A SmFeN-based rare earth magnetic powder, comprising Sm, Fe, and N,
wherein the SmFeN-based rare earth magnetic powder comprises at least 6% by mass but not more than 10% by mass of Zn based on a total amount of the rare earth magnetic powder, and
wherein the SmFeN-based rare earth magnetic powder has a particle size D50 corresponding to a 50th percentile of a cumulative particle size distribution by volume of the SmFeN-based rare earth magnetic powder that is at least 1 μm but not more than 4 μm, a residual magnetization σr that is not less than 120 emu/g, and a squareness ratio Hk that is not less than 13000 Oe.

8. The SmFeN-based rare earth magnetic powder according to claim 7, having the squareness ratio Hk that is not less than 15000 Oe.

9. The SmFeN-based rare earth magnetic powder according to claim 7, further comprising La, W, and R, wherein R is at least one selected from the group consisting of Ti, Ba, and Sr.

10. The SmFeN-based rare earth magnetic powder according to claim 7, comprising:
a main phase containing Sm, Fe, and N; and
a coating layer coating the main phase,
wherein the coating layer contains Zn localized on a main phase side, and
wherein the coating layer comprises a Zn-containing region and a P-containing region located outwardly from the Zn-containing region.
